(19) United States
(12) Patent Application Publication
(10) Pub. No.: US 2005/0043980 A1
(43) Pub. Date: Feb. 24, 2005

(54) Quote and supply management system

(76) Inventors: Andrew Craig Edlin, Thornlands (AU); Peter Syme Taylor, Hamilton (AU)

Correspondence Address: ROTHWELL, FIGG, ERNST & MANBECK, P.C., 1425 K STREET, N.W., SUITE 800, WASHINGTON, DC, 20005, US

(21) Appl. No.: 10/481,759

(22) PCT Filed: Jun. 28, 2001
(86) PCT No.: PCT/AU01/00771

(51) Int. Cl. G06F 17/60

(52) U.S. Cl. 705/8

(57) ABSTRACT

A computerised management system for a business schedules a date to provide a quote for the provision of a product or service, in response to a client request; stores data relating to a quote approved by a client; schedules resources, such as labour and goods, required for the provision of the product or service relating to an approved quote; and stores a provision deadline corresponding to the date by which the product or service should be provided to the client.

### FIELD OF THE INVENTION

The present invention relates to business management and is particularly concerned with servicing businesses such as those associated with installing security screens.

### BACKGROUND OF THE INVENTION

The process of servicing a product in a retail and/or wholesale market is both complicated and time consuming. The demand on a business to perform to a high level while keeping control of costs is difficult and with a limited time available to ensure that all the required processes are carried out it is extremely difficult to effectively manage the performance of many varied processes.

As an example during particularly busy periods the focus of many businesses is on the most urgent and pressing issues at the time and they rely on manual processes to ensure that other required duties are addressed during this period.

Therefore reporting systems within the business are often minimal, leading to problems arising that are often difficult to rectify.

There are areas outside the “quote and service” areas such as debtors, payroll etc that require constant monitoring. Because smaller businesses tend to operate with small profit margins, quite often there are insufficient resources to control all the areas of business management that need to be controlled.

The aim of the present invention is to provide a management system which is able to assist management of a business.

In its preferred form the invention provides a management system which is able to be implemented utilising data processing hardware and software to assist with management of a business.

Existing software systems for businesses primarily are concerned with accounting functions of a business. Some software systems also include electronic diaries for business management purposes, but these electronic diaries do little to assist with management of a business.

### SUMMARY OF THE INVENTION

According to the present invention there is provided a management system for a business, which management system is adapted for implementation by a computer, the management system comprising a job inquiry and quotation means which is adapted to receive data relating to a request from a client to provide a quote for the provision of at least one product and/or service and operate a quote scheduling means to retrieve predetermined quote data whereby a schedule is created for a quote date being a date for providing the quote to the client, a job management means which is adapted to receive data relating to a successful quote approved by a client, including the or each product and or service requested by the client and operate an operations scheduling means to retrieve predetermined operations data to create an operations schedule to schedule resources required for the provision of the or each product and/or service for the successful quote and store a provision deadline being the date by which the product and/or service of the successful quote should be provided to the client who approved the successful quote.

Preferably the operations scheduling means is adapted to schedule labour and goods required for the provision of the or each product and/or service for each successful quote.

Preferably the resources includes labour and goods.

It is preferred that the operations scheduling means is adapted to schedule procedures involving the resources, which procedures enable the provision of the or each product and/or service for each successful quote.

Preferably the management system includes an administration means which is adapted to record data relating to input and output costs of the business being managed by the management system.

It is preferred that the job inquiry and quotation means comprises a module in a computer program.

The job management means may comprise a module in a computer program.

The job inquiry and quotation means and job management means preferably include separate input icons accessible from a main menu of the management system.

The administration module may be adapted to communicate accounting data from the management system to an independent accounting program.

Alternatively the administration means comprises accounting procedural processes for providing accounting reports.

It is preferred that the job inquiry and quotation means is adapted to create a job inquiry labour database for storing names of persons able to act on the inquiry and provide the quote.

Preferably the job inquiry and quotation means is adapted to create a database of products and/or services available for the quote.

The operations scheduling means preferably includes quote allocation means which is adapted to allocate a quote person from the job inquiry labour database to provide the quote.

Preferably the job inquiry and quotation means is adapted to create a pending quotes request database including data relating to the client requesting the quote and the or each product and/or service for which a quote is requested.

Preferably the quote data includes the quote person, the client, the product and/or service, the date for visiting a client and the due date for supplying the quote.

The job inquiry and quotation means may include quote monitoring means for monitoring when each quote request is answered by the quote person.

Preferably the job inquiry and quotation means is adapted to create a source of inquiry database which includes a list of sources of inquiries.

It is preferred that the management system includes a settings means which is adapted to receive reference data relating to each product and/or service available to the business.

Preferably the job inquiry and quotation means includes a data entry means which is adapted to receive data relating to the request from a client, being a new job, and create a file for each new job.

It is preferred that each job file includes data relating to the client and the product and/or service requested by the client.

It is preferred that the data entry means includes the quote scheduling means.

Preferably the quote allocation means is adapted to retrieve quote persons names from the job inquiry labour database whereby one or more quote persons names may be added to the new job file to thereby provide the quote requested by the client.

According to one embodiment the quote allocation means automatically searches databases and allocates a quote person to a new job based on predetermined criteria relating to jobs already allocated to the quote person.

According to a further embodiment of the invention the quote allocation means is adapted to retrieve data from databases and create a file for each quote person which file includes data relating to each quote/job, the quote person has yet to provide.

Preferably the quote allocation means is adapted to create a file listing all jobs/quotes which do not have a quote person allocated thereto.

It is preferred that the quote allocation means includes a quote person scheduling means for determining the quote person with the least amount of jobs/quotes and allocating the new jobs/quote to that quote person.

The source of inquiry database may include files with fields for different types of advertising, names of referees, names of exhibitions or any other source of obtaining an inquiry.

Preferably the quote monitoring means includes an overdue indicator which is adapted to provide an overdue output indication if a quote request is not answered by the due date.

The job inquiry and quotation means preferably is adapted to record unsuccessful quotes and data related thereto.

The job inquiry and quotation means may include quote report means which is adapted to retrieve data from the job inquiry labour database, the products and/or services database, the quote request database and quote monitoring means and process selected retrieved data to output statistical data including one or more of the following:
inquiry source, quote person, client location and type, product, service, speed of quote provision, cancellation of quote request by client, cost quoted and strike rates.

Preferably the job inquiry and quotation means includes a job inquiry manifest means for creating a job manifest for each quote request using data from anyone or more of the databases.

It is preferred that the job inquiry manifest means is adapted to create a job manifest for each quote person.

Preferably each job manifest includes data relating to each quote request including client details, product and/or service details and due date details.

Preferably the job inquiry manifest means is adapted to create a job manifest for each quote person.

The job inquiry and quotation means preferably includes a job leads manifest means for creating a job leads manifest including a list of all leads which may be the source of a request for a quote for a product and/or service.

It is preferred that the job leads manifest includes data relating to the names of any potential new client associated with the lead.

It is preferred that the quote scheduling means is adapted to schedule quote labour, a visit deadline, being a date for the quote labour to visit the client and obtain data required to prepare the quote.

It is preferred that the job inquiry and quotation means includes quote management report means which is adapted to retrieve data from databases and create files grouping predetermined types of data together.

According to one embodiment the predetermined data types grouped together may be that relating to a quote person, a region where clients are located, an advertising source or other statistical information.

It is preferred that the job inquiry and quotation means includes a quote job control means which is adapted to retrieve data relating to jobs with an expired due date.

It is preferred that a job/quote file includes a completion date field which is adapted to receive a completion date that is before the due date.

The quote job control means is adapted to add a job/quote file to the quote job control file if the current date is past the due date and there is no completion date in the completion date field.

It is preferred that the quote job control means is adapted to create an unallocated jobs file which is adapted to retrieve files for job/quotes which do not have a quote person entered in the quote person field.

The job management means may include a resource database including data relating to each product and/or service able to be provided by the business, raw materials available to make the or each type of product and/or service and resource labour available to provide each type of product and/or service.

The resource labour may include manufacturing labour available to manufacture one or more types of product.

The resource database may include data relating to each type of product available in stock.

Preferably the resourcing database includes data relating to raw materials and/or products which need to be outsourced.

The job management means may include a manufacturing operation means which includes procedures required to manufacture at least one type of product.

The manufacturing operation means may include timing data for setting times for commencing and finishing procedures required for manufacture of one or more products.

The operations scheduling means may include resource allocation means which is adapted to retrieve data from the resource database and allocate resource labour to produce at least one product and/or service required for one or more clients.

It is preferred that the predetermined operations data includes that data stored in the resource database.

It is preferred that the operations scheduling means is adapted to create a file having data relating to a job/quote, the products and/or services associated with the job/quote and the manufacturing operating means.

It is preferred that the manufacturing operation means includes a plurality of manufacturing operations options, each manufacturing operation option being adapted to store data relating to procedures required to complete at least one manufacturing process for a product.

It is preferred that the manufacturing operation means includes a process scheduler which is adapted to store timing data for at least one of the manufacturing operations for a particular job/quote and calculate and produce timing data associated with other manufacturing operations for the job/quote.

It is preferred that the process scheduler creates a file which is able to be viewed on a computer screen.

It is preferred that the management system is able to create files for data stored in any one of the data bases and present this on a computer screen for viewing.

It is preferred that any file created by the management system is able to be viewed on a computer screen.

It is preferred that the process scheduler is able to reschedule a job/quote by comparing a completion date received for that job/quote with completion dates for other job/quotes stored on a process scheduler data base.

It is preferred that the process scheduler is adapted to retrieve data from the operations schedule.

It is preferred that the product resource labour is adapted to either manufacture product or procure product from a source outside the business.

The resource allocation means is preferably adapted to retrieve procedures from the manufacturing operation means, which procedures are required to produce the/each product and/or service whereby a resourcing manifest is able to be created including data relating to the requested product and/or service of the successful quote, the allocated product resource labour and completion date for providing the/each product and/or service whereby it is available for the client of the successful quote.

Preferably the management system includes provision control means which is adapted to record each provision date, being the date for providing the or each product and/or service of a successful quote to the associated client.

It is preferred that the provision control means retrieves the completion date from the resourcing manifest.

Preferably the resourcing allocation means is adapted to allocate provision labour, including a provision person, being labour for providing the or each available product and/or service of a successful quote to an associated client.

The provision control means may include a provision database including data on each provision person available to provide the or each service to an associated client.

The provision control means may be adapted to create a provision manifest including the name of each provision person to provide the or each product and/or service, provision procedures including procedures to provide the or each product and/or service to an associated client and a provision deadline being a deadline for providing the or each product and/or service to the associated client.

The provision control means may include a provision overdue data indicator which is adapted to output an indicator for indicating when the provision date has passed and the or each product and/or service has not been provided to the associated client.

It is preferred that the provision control means comprises an installation control means which is adapted to record an installation date or dates for installing the or each available product and/or service to the associated client.

According to a preferred embodiment of the present invention the job management means includes the provision control means.

It is preferred that the provision control means is a module in a computer program associated with controlling activities associated with labour and products required to install a product at a clients residence.

Preferably the job management means includes an outsourcing means which is adapted to retrieve data from a job/quote if the job/quote includes a product and/or service which the business does not have.

It is preferred that the order means is adapted to create a file listing all jobs/quotes and their products and/or services which must be ordered from outside the business.

It is preferred that the order means includes an order due date field for entering a date by which the order should be filled.

According to another embodiment of the present invention the job management means includes a check measure means which is adapted to receive data from a particular job/quote and create a file listing measurements of products required for that particular job/quote, whereby a checking procedure is able to be initiated.

It is preferable that the manufacturing schedule includes a check measure field which indicates that measurements have been checked.

It is preferred that the check measurement field overrides manufacturing operations from being accessible/commenced until the check measurements field has been completed.

It is preferred that the operation scheduling means is adapted to transmit data to the provision control means for each job/quote which has been approved, which data includes a check measure request which is to be actioned by a provision person.

It is preferred that the management system is in the form of a computer program which is able to control a data processor utilising the job inquiry and quotation means and the job management means.

According to another aspect of the present invention there is provided a computer program for controlling a business, the computer program comprising a job inquiry and quotation means which is adapted to control a data processor to receive and store data relating to a request from a client to provide a quote for the provision of at least one product and/or service and operate a quote scheduling means to schedule a quote data being a date for providing the quote to the client, and a job management means which is adapted to control a data processor to receive data relating to each successful quote approved by each client including the or each product and/or service requested by each client, control an operations scheduling means which is adapted to schedule labour and goods required for the provision of the or each product and/or service for each successful quote and store a provision deadline for each successful quote, the provision deadline being the date by which the product and/or service of the successful quote should be provided to the client who approved the successful quote.

Preferably the quote scheduling means is adapted to schedule quote labour to provide the quote.

The quote scheduling means may be adapted to schedule a quote deadline for the quote labour to provide the quote.

Preferably the quote scheduling means is adapted to schedule a visit deadline being a date for the quote labour to visit the client and obtain data required to prepare the quote.

According to one embodiment the quote scheduling means is adapted to control the data processor to set up a quote labour manifest including data relating to selected successful quotes allocated to the quote labour.

The quote labour manifest preferably includes data relating to any one or more of the following:
the source of inquiry of the quote;
the client associated with the quote including the client type and location;
the or each type of product and/or service for which a quote is required by the associated client;
deadline for providing the quote;
deadline for visiting the client to obtain data for providing the quote;
accounting data including costs and revenue;
Strike rates, being the number of successful quotes per quote.

It is preferred that the job inquiry and quotation means is adapted to set up a leads manifest being a database of information relating to potential sources of request for quotes.

It is preferred that the leads manifest includes a follow up deadline which provides a prompt to contact the lead to ascertain whether a quote is required.

Preferably the operations scheduling means is adapted to schedule for each successful quote a completion date, being a date by which the or each product and/or service requested by each client, should be made available to provide the or each client.

Preferably the operations scheduling means is adapted to schedule for each successful quote provision labour to provide available products and/or services to a respective client.

The operations scheduling means may be adapted to schedule resource labour, being labour for providing the or each product and/or service of the successful quote by the completion date.

The operations scheduling means may be adapted to schedule product resource procedures for each type of product and/or service of each successful quote whereby resource labour can provide the or each product and/or service by the completion date.

Preferably the operations scheduling means is adapted to allocate provision labour to provide the or each product and/or service to a client of a successful quote by a provision deadline, being the date the or each product and/or service should be provided to the client of the successful quote.

Preferably the computer program includes an exceptions means which is adapted to output an exceptions indicator whenever any deadline is passed without necessary actions being taken.

It is preferred that the computer program includes management report means for retrieving selected data stored on a data processor as a result of controlling operations by the job inquiry and quotation means and the job management means.

It is preferred that the management report means is adapted to retrieve data from any manifest stored on a data processor under the control of the computer program.

It is preferred that the operations scheduling means is adapted to communicate with an operations procedure means of the computer program to retrieve predetermined data on procedures required in order to provide at least one of the products and/or services, whereby labour allocated to provide the or each product and/or service is able to access the operations procedures to follow the procedures and provide the or each product and/or service by the completion date.

Preferably the operation procedure means provides a time period for providing at least one of the products and/or services.

The words “comprising, having, including” should be interpreted in an inclusive sense, meaning that additional features may also be added.

### BRIEF DESCRIPTION OF THE DRAWINGS

Preferred embodiments of the present invention will now be described by way of example only with reference to the accompanying drawings in which:

FIG. 1 shows a flow diagram for a management system according to a preferred embodiment of the present invention;

FIG. 2 shows a flow diagram of a sales module of the management system shown in FIG. 1;

FIG. 3 shows a customer service module of the software management system shown in FIG. 1;

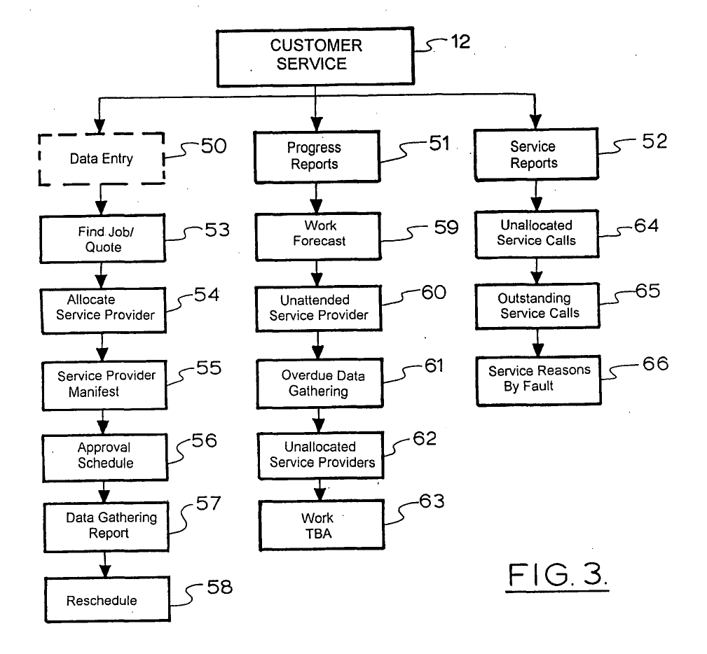

FIG. 4 shows an operations module flow diagram of the software management system shown in Figure;

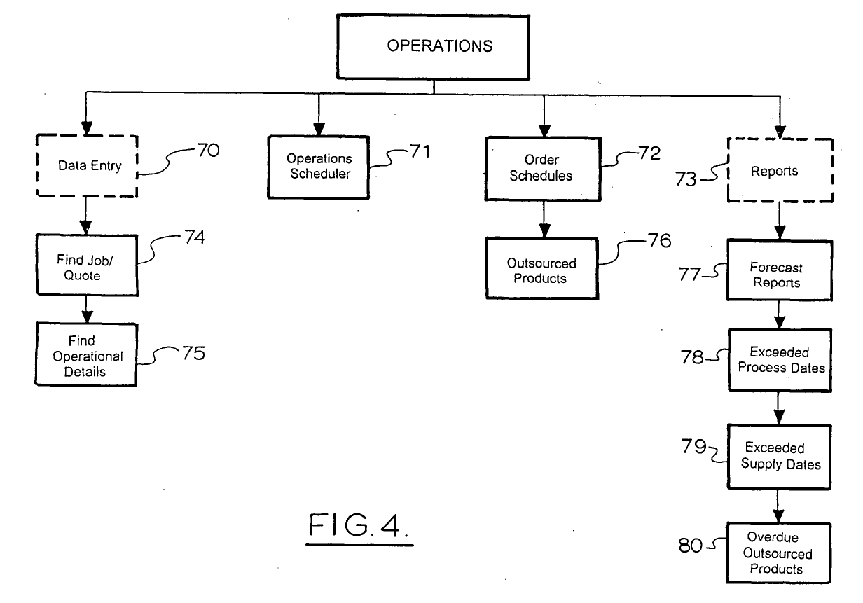

FIG. 5 shows an administration module of the software management system shown in FIG. 1; and

FIG. 6 shows a flow diagram of the business management system according to the preferred embodiment.

### DETAILED DESCRIPTION OF THE DRAWINGS

According to the preferred embodiment of the invention a management system is described as implemented using a computer program.

The preferred embodiment describes an application of the invention in a business involved in providing security screens for buildings.

The aim of the management system is not to identify minute details associated with every type of a business but is aimed at identifying the key tasks in management and running of a sales, operations and service business. A management system is then created using these key areas to systemise the processes so that they run efficiently and effectively. By doing so management can begin to work on the business in contrast to adversely working in the business.

This time saving enables management to take advantage of the system reports available within the business and to take a proactive stance towards the future rather than the reactive stance most businesses are forced to adopt because of inadequate resources in the management and administration areas.

The preferred embodiment is intended to be a real time management tool for managing the key areas of a business.

According to the preferred embodiment four key areas are identified within the management system. These are sales, service, operation and administration.

In sales the initial focus is in the qualifying of leads and the creation of a work sheet (manifest) for the sales representatives.

The response to the quotes is then measured with approved jobs going into the operations and service areas while the still outstanding quotes (pendings) are managed through a specialised follow-up program).

Performance reports are available for the entire sales process as well as exception reports (exception reports are reports listing work tasks that have been missed or neglected by the staff).

In the service and operations area, the process involves securing the exact requirements relating to the product or service and the confirmation of the dates the job is to be supplied or completed. Once the product is available or the service is able to be performed, the manifest of work is created for either the supply of, or the installation of, the product or service.

This is not limited to including the primary work, but also any service calls that are required.

There is also a verification process available if the sales staff are not adept at understanding or servicing the final product or service.

This process allows for the use of specialists rather than service providers performing in the sales area. All processes are once again backed up by both management reports and exception reports in order to ensure that jobs are on track and provided on the data arranged with the customer.

The operations area, working off the delivery or installed dates provided by the service area, is provided with an operations schedule.

This schedule is calculated by the system and determines the date upon which the product or service is required to be in operation in order for the product or service to be supplied or installed on the correct date. The system can take into account any product regardless of its origin. This whole process is structured by each individual business by simply utilising a “schedular” program. This program acknowledges a turn around time for any given product or service. The business is then supplied with a forecast report showing any operational procedures required on a given day, any finished product or service that may need to be sourced and any other product or service that needs to be available at a given date to ensure the supply or installation of the product or service by the required date.

Exception reports in this area are used to determine if a product or service is running behind schedule, enabling the business to react in time rather than disappointing a customer.

The administration side of the system covers those onerous jobs that are required in a business and can be so easily overlooked.

These may be the time consuming and tedious tasks, the hard to control tasks and the necessary tasks required by business with regard to tax issues.

Integral to the system is the reconciliation capacity of the system which monitors, sales, receipts, GST, etc.

The system monitors and calculates wages for sales and operational staff, has a complete debtors program, monitors banking and invoicing etc. This makes the administration side of a business both structured and accurate.

The system is intended to be a complete business plan.

It is preferred that the system enables any retailing or wholesaling business to control its products, services and work force. It enables a business to control measure and use the available resources to maximise both profits and its penetration into the marketplace.

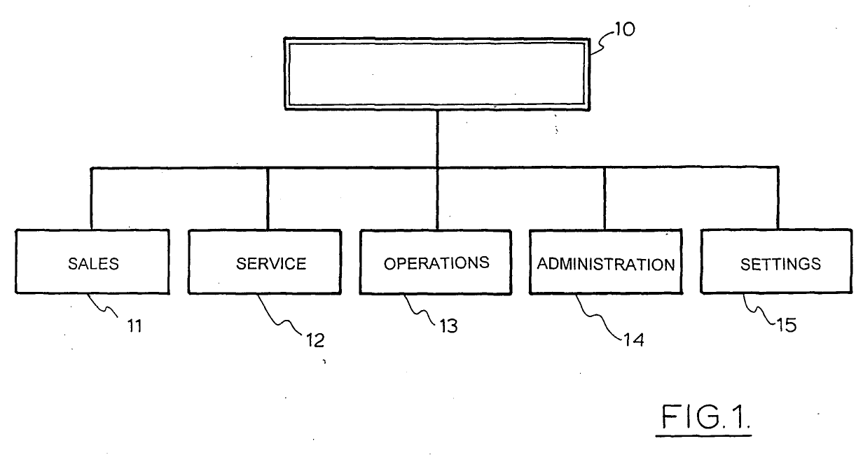

FIG. 1 shows a work flow diagram of five key modules of the management systems software 10. These modules include a sales module 11, a service module 12, a scheduling module 13, an administration module 14 and a settings module 15.

It is noted that the settings module is an activity usually only performed when setting up a new system.

It should be noted that for the preferred embodiment, it is desirable to split the particular key tasks in the manner described. However, in practice many of the operations falling within each module may overlap.

Sales

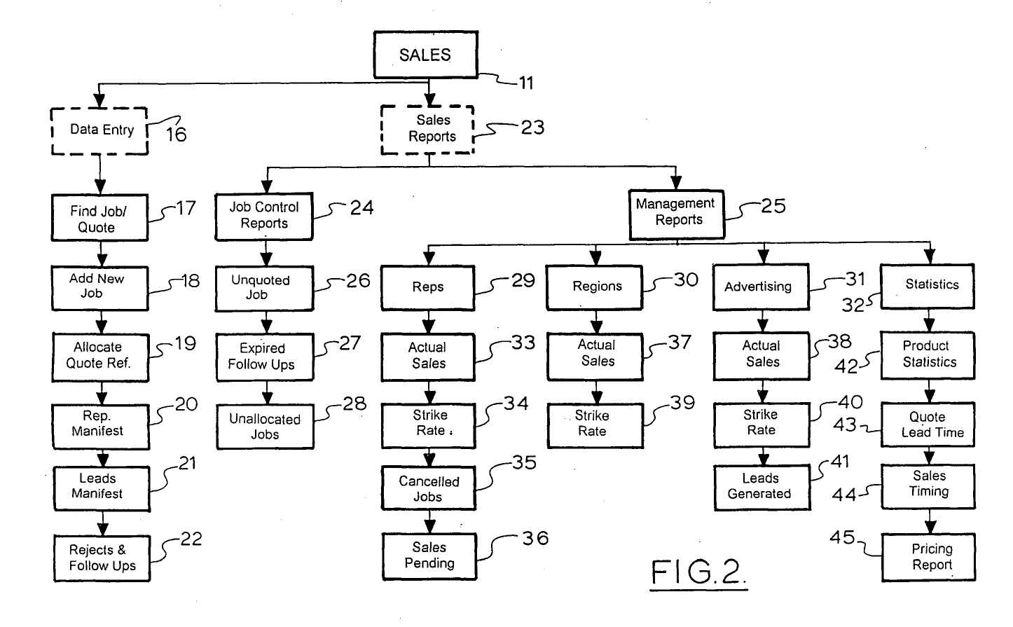

As shown in FIG. 2 the management system software includes a sales modules which is designed to control data processes involved with the sales area of a business and to also maximum the effectiveness of a sales division by integrating processes that will assist in an increased conversion of quoted jobs into approved jobs.

Sales effectiveness can be influenced by a number of factors, the foremost being the ability of a company to ensure all leads generated within the business are serviced and followed through.

Advertising and lead generation programs can be a costly and time consuming exercise. It is therefore important that the opportunities to create sales are not wasted due to the inability to control and manipulate the work flow.

There are two types of leads generated into the business. The first of these is a customer requiring an appointment on a particular date. These are entered directly into the system to appear on a sales representative's work sheet. The second is a lead generated through such various forms of advertising a business may involve itself in. These leads are entered into the leads generated section of the system.

Due to their nature these leads need to be requalified to take them from the lead status to an appointment status which in turn will then direct them to the representative's work sheets. All customers on the leads generated list are phoned to ensure that all representative's work sheets, (manifests), represent quotes and that they are not loaded with poorly qualified work.

Once manifests are issued the system tracks the performance of the sales representatives to ensure that all appointments are serviced. Reports are available to management that track performances in all areas of sales measuring such factors as strike rates, actual sales, product statistics etc. These performance indicators can be used to measure the effectiveness of any current work procedures and to measure any changes should the current work procedures be altered.

Exception reporting is also available to sales and is used to assess whether the work allocated to staff members is being carried out within the allotted period. This type of reporting is critical to maximising the effectiveness of advertising and the approval rate when quoting.

In general sales are about controlling the leads generated through controlled and measured advertising, correctly servicing those leads and following all work through to a conclusion.

The management software system offers the tools required and applied correctly can increase business performance in all areas of sales.

As shown in FIG. 2 the sales module of the management software is based on a sales flow chart for the business.

With any new job it is necessary to enter data relating to that job.

The type of data entered depends upon the particular situation. Thus the sales software 11 contains a data entry menu 16 which includes a find/job quote icon 17 which has an associated sub-program which is designed to receive data relating to a customer and initiate a search routine to produce a customer file containing data relating to the products for which the customer requires a quote, the install date for the products, if any service calls are required or have already occurred, invoice details, payments, commissions, adjustments and job details. The available data in each customer file is a recorded history of the past and present customers. All transactions and future movements of a customers product are available and kept after completion for future references.

Another option for the data entry is an icon called add new job 18. This icon is associated with a sub-program which enables a new job to be created.

The sub-program 18 prompts data entry on a new customer such as the customer surname, suburb, job source, job group and date.

A database is thus created of jobs/quotes for particular customers. For a new job it is necessary to allocate a sales representative to do the job of providing a quote to the customer.

Accordingly the data entry menu 16 includes an allocated quote rep icon 19. This icon is associated with a sub-program which when activated by an inquiry searches through the database of customers/job/quotes to produce a list of any quotes which have not had a sales representative allocated thereto. A sales representative can then be added in an appropriate field associated with a particular job.

Thus a sales database is created with data such as job details, customer, install date, sales representative which may be searched to access a particular file. Thus for the example given there are eight tabs which each contain file data relating to the name of that tab.

Once job files have been created and relevant data entered into the relevant tabs, it is necessary to provide each quote representative with reports in the form of a representative manifest. These representative manifests provide instructions to the sales representative with regard to their work load for any given date.

A representative manifest icon 20 is provided as an option in the data entry menu 16.

The representative manifest icon is associated with a sub-program which provides access to a database of manifests for each sales representative.

The representative manifest includes data on each job number and customer details as well as appointments and date to be quoted and a follow up option, where customers previously quoted require a follow up call that evening.

When a representative manifest has been created the manifest is given to the sales representative the day before the quote is to be done. The date is only booked for the sales representative and an exact time for the appointment is to be decided between the customer and the sales representative when the sales representatives phones the evening before. This enables the sales representative to make up a schedule that best suits for efficiently getting around to all of the appointments.

Follow up calls are to be phoned on the day of receiving the manifest. All results of the phone calls (a yes, no, or another follow up date) must be handed back to administration personnel for processing. If a sales representative fails to follow up their customer the job will appear on their expired follow up report.

A typical sales manifest includes job number, customer name, address, description of products requiring a quote for supply and installation, final price, phone, after hours phone number, quote deadline and a description of the action required by the sales representative.

As an example this would be measure and quote.

Another important part of the sales software is the creation of a leads manifest 21. This leads manifest 21 appears as an icon in the data entry menu 16 and enables a listing of leads requiring a further phone call to qualify them before a job is allocated to a sales representative.

An example of this would be a home show with leads for new houses that are up to six to nine months in the future. The system will keep (in order of date) reminders to phone the client to see if the time is right for a quote.

The leads manifest always uses the company name as the representative. Therefore if a reminder call is not made when it is supposed to be made, the representative in this case the company, will appear on the unquoted jobs report.

The leads manifest icon therefore is a header for a sub-program which accesses a database of leads with this database having a job number, customer name, customer address, job description, final price, phone, after hours phone number and the date of allocation.

A final option in the data entry menu 16 a rejects and follow-up icon 22 which is a sub-program which provides access to a database of jobs referenced by job number and customer name and detailing follow up dates whether the quote is still pending or whether the quote has been rejected. The sub-program also includes a search routine for accessing a particular job number.

Another function of the sales software program 11 is to provide sales reports.

These sales reports are accessed through a sales report option 22 which appears as an icon when entering the sales program 11.

The sales report header 23 provides two options identified by a job control reports icon 24 and a management reports icon 25.

The job control reports icon provides access to three options. These include an unquoted job icon option 25, an expired follow-ups option icon 26 and an unallocated jobs icon option 27.

Because leads are an integral part of any business and it is important that all leads are attended to the unquoted jobs icon 25 is a header for a sub-program which lists all leads that have been allocated to a representative to be quoted, but have had no results entered into the system three days after the quote deadline. Because leads are important to the business all results from these leads are measured in the software management system for effectiveness.

Typically “unallocated jobs” is the first report in a series of reporting that ensures company procedures for maximising the effectiveness of leads is followed through by its employees.

The expired follow ups icon represents a header for a sub-program which lists follow-ups where no results have been given to administration staff of the business.

Unallocated jobs icon 27 provides list of all jobs that have been unallocated.

Many different reports may be obtained by accessing the management reports sub-program 25. The options available include management reports on representatives 29, regions 30, advertising 31 or statistics 32.

The representatives option 29 provides four different types of management reports including actual sales 33, strike rate 34, cancel jobs 35 and sales pending 36.

Each of the icons is associated with a sub-program which is able to access data from databases which have already been created in the data entry mode of the sales program.

Actual sales reports provide various options for analysing a representatives performance. A strike rate report enables the success rate of representatives to be monitored. This being the number of jobs quoted for against the number of jobs accepted by the customer. Management reports for cancel and sales pending are self-explanatory.

Regional based reports and advertising based reports under icons 30 and 31 also enable management reports to be provided based on actual sales or strike rates as represented by icons 37, 38 and 39 and 40 respectively.

The advertising management reports also include an option to monitor leads generated through option 41.

General statistical information is available by accessing the statistics option 32. This enables management reports based on product statistics 42, quote lead time 43, sales timing 44 and pricing reports 45.

It should be apparent from the above that the sales management software 11 is able to monitor and effectively control all important aspects of the sales area of a business. For convenience the sales management software has been described in relation to a flow chart as shown in FIG. 2.

Service

When a job has been successfully quoted and approved by a customer another phase of business management is required in order to provide the required product to the client and install it.

As product is ordered through the sales area the commitment dates for delivery are dependent upon the service department to ensure the supply and service is both professional and timely.

The business management software enables a business to control all supplied products by setting the agenda for the timing and supply and ensuring all products are available and ready on the supply date.

When a job is approved an installer needs to be allocated to the job. In the security screen business example of the present invention it is not merely a simple task of sending an installer out to the customer a few days after a quote has been approved by the customer.

Typically products required in order to install a security screen or other associated products must be either manufactured by the business or procured from outside the business.
if manufacturing is required this also means that raw materials need to be provided so that the manufacturing process can occur.

All of the processes necessary to provide products so that the installer is able to do his/her job requires management scheduling.

The first step with the customer service side of the business is to enter data.

Thus in a similar fashion to the sales management module a data entry sub-program is provided which lists a number of menu icons which each head a sub-program for conducting particular operations.

The customer service module 12 can be broken into three sub-modules consisting of a data entry module 50, a progress reports module 51 and a service report module 52.

The data entry module 50 has a find job/quote module 53, an allocate service provider module 54, a service provider manifest 55, an approval schedule 56, a data gathering report icon 57 and a rescheduling icon 58.

The find job/quote icon 53 provides a mechanism for searching through files and accessing data as required, based on job number, quote number or the customers name.

By selecting the allocate service provider option a sub-program is initiated which lists each job number, customer name, installation address, suburb and the date of approval of a quote.

Additional fields are also provided in a provider file including the name of the service provider and an install date.

In a similar fashion to the sales module 11, a service provider is allocated a job. This is analogous to a quote representative being allocated a job.

Furthermore a service provider manifest is created by utilising the service provider manifest option 55. Thus a service provider is able to access their manifest by entering the service provider manifest option and typing in their name. A program is then initiated to search for the service providers manifest file stored on a database and retrieve this for viewing by the service provider. The service providers manifest includes jobs that will have a service provided, service calls and jobs requiring further data.

Thus one service provider will have a manifest including details on a job number, customer name, address, phone number, complete installation date, paid date and a description of what needs to be installed including coded product names, and quantity.

Thus each service provider is able to obtain a report outlining what their duties will be and the deadline for performing these duties.

Because it is important to obtain up to date data on what service providers are doing the customer service module 12 includes approval schedule module 56 which sets a date for data gathering for a service provider as well as the date the service will be provided.

Typically the data gathering date is allocated a few days after the approval is entered into the system.

The service provider then arranges a final date allowing for the set turn around time for the service to be scheduled.

Once details have been entered in an approval schedule file for that service provider a data gathering report sheet is able to be provided by the approval schedule program for the service provider. On the sheets the service provider fills in the data necessary for the service to be provided.

The approval schedule file includes a field for entering a production date for the products required to be installed as well as a factory pick up date.

The data gathering report is used for the generation of data gathering sheets for a selected job.

By entering a job number a report will be generated for that job only. The data gathering sheets record the finished sizes of products required for installation. They also include diagrams of doors and grilles, instructions for installation, job number, customer name and customer address details.

Because the data gathering sheets produced by the data gathering report module 57 are listing of all services required for a selected job, each service item is individually listed with check boxes for the service provider to complete.

The completed data gathering sheets are used as a data entry for a scheduling process.

Because each service provider needs to know in advance what work must be done the progress reports module 51 is used as a forecasting mechanism.

The progress reports module 51 includes menu module items work forecasts 59, unallocated service provider 60, overdue data gathering 61, unattended service provider 62, and work TBA 63.

A work forecast report is set up by the work forecast module 59. This report is used to forecast what work a service provider has between any date range. The report advises the service support staff that within a selected period they should be aware of the following details which are fields in work forecast report file:

What service group does the service come under?;
What is the service type?;
Which service provider (“or all”).

To use the report the service support staff may choose any one of the fields in the service group, service or service provider categories. Alternatively the service support staff may leave any of these fields blank which will automatically select all combinations in that category.

The work forecast report enables the average workload of any particular service provider to be reviewed. This can then be used as an indicator or whether that person is able to service the quantity of clients or is under utilised.

It follows therefore that the report is used when allocating jobs to service providers because it helps determine which providers are available.

It is important that there is a self-checking mechanism to ensure that all customers are being properly serviced. Accordingly unallocated service provider module 60 enables a list of jobs to be provided which have approved quotes but which have not been allocated a service provider.

The overdue data gathering module 61 is a means for ensuring that all data gathering processes are completed by a service provider.

Therefore if a data gathering deadline has passed an exceptions report is produced which is able to be sent to management and to the service provider. The overdue data gathering module is able to retrieve data and store it in a file including job number, clients name, data gatherers name (usually the service providers), date the data was to be gathered for that job, service deliverers name (usually the service providers), and date that the job is to be finalised.

The report which issues from this module is used to monitor that all data gathering processes have been completed so that the final dates can be forecast and fulfilled. This process also enables the client to be informed if any changes are made to allocate dates.

The unattended service provider module 62 initiates procedures to produce an exceptions report listing all jobs that have a data gathering date but which do not have a final date.

It is the responsibility of each service provider to organise the final service date with the client. From the data gathering date and from using turn around times, the service provider can arrange a final date with the client. If that date is unsuitable to the client then a date after the date proposed by the service provider can be organised.

The work TBA module is able to provide a file listing all jobs that have been approved and put on hold. A comments field is provided against each job number so that the reasons for the job being put on hold can be reviewed.

As part of the installation process it is frequently necessary to have follow up service to either install additional components or to check and maintain the initial installation. For this reason a service reports module is provided as part of the customer service module.

The service reports module 52 includes the options of an unallocated service calls module 64, an outstanding service calls module 65, and a service reasons by fault module 66.

The unallocated service calls module provides a file listing service calls that have not yet been assigned to a service provider. This may be because the service calls often occur months after the final date of installation.

The outstanding service calls module 65 is able to access data on each job and produce a file of outstanding service calls. A report is then able to be issued for the service provider to attend to these outstanding service calls.

Because it is important that all installation jobs meet a certain level of quality it is important that feed back is obtained or there is a problem associated with an installation. However the module 66 is also able to be used to monitor any faults in the overall management procedure covered by the management software. If any person involved in the quoting to installation procedure perceives a fault to have occurred this can be entered into a file created by the service reasons by fault module and a list of these faults can then be reviewed by management.

Operations

The management system so far has outlined the processes required in order to manage job quotation operations as well as customer service operations. However it is important that products required for the customer service part of the management system be made available so that installation dates can be met.

Accordingly the operations process is necessary to produce all products sold in sales before the due date of supply. In order to perform this task an operations module 13 is provided which is able to access and store data and schedule particular operations.

Every product has a set procedure. Whether the product is completely fabricated in house or is purchased and brought in as a completed item, it still requires a process in order to be available to the installation team (service provider) upon a given day. Each product is therefore given an ID number which in turn will have a sequence of procedures that are required for that particular product in order for it to reach the completed product stage. When products are sold they are processed into the operations area through the process schedular. This schedular sorts the varied processes of the individual products, notes the supply date and sets those processes into a formal onto daily worksheets.

The worksheets enable a business to view the upcoming workload. The business is then able to foresee any shortages in materials, calculate the staff levels required to complete the work, or have the ability to move an operation process in order to flatten out work flow so as not to follow the up and down trends of sales.

It is possible to monitor any shortfalls and forewarn management of any products that are exceeding the date that will prevent the product being ready to be supplied on a committed date. This is achieved by way of exception reports which are produced by individual modules of the operations module 13.

In summary the management system is able to control work flow, monitor work performances and sequences to ensure all products, regardless of the type are ready for supply on an agreed date.

The operations module 13 is split into four sub modules including a data entry module 70, an operations schedular 71, an order schedules module 72, and a reports module 73.

The data entry module 70 includes two options. One of these is a find a job/quote module 74, and the other is a find operational details-75.

The find job/quote module 74 is similar to that described in relation to modules 53 and 17.

The find operational details module 75 is used to enter operational details after verification is completed by an employee or to simply view what operational details have previously been entered.

A file (as shown in Table 1) is created of operational details which lists the products sold by a particular sales representative. The products in the files should be listed as per the original quotation by the sales representative.

All of the processes required to complete a product for delivery are listed under their own tab. These include cut products, cut orders, powder coating, rework products, cut accessories, rework accessories, job details.

Each process can be viewed to determine the status of the product at any time.

The operations schedular module 71 creates and stores scheduler files associated with each product. Each product will have its own processes in order to be completed to the supply stage. In the settings module 15 each products processes and time sequence on those processes is set into the system.

TABLE 1

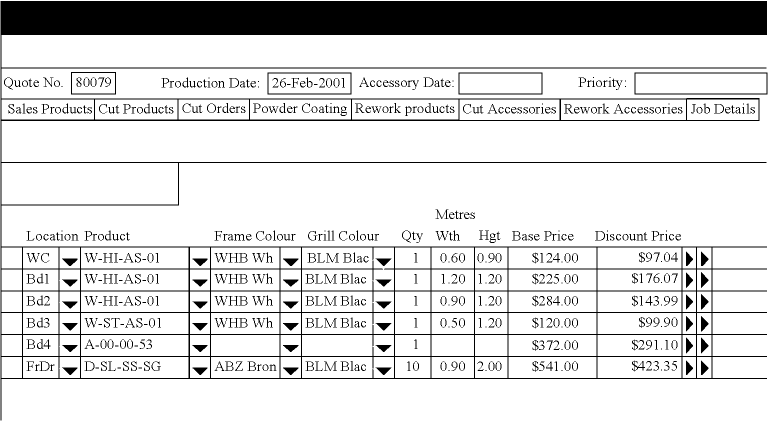

Each product has operational details which are automated and driven by a supply date of a job. The operation schedular however includes a cut scheduler which enables a user to have flexibility, whereby it is possible to change one or all of the dates for processes involved in the manufacture of a product.

The cut scheduler (as shown in Table 2) is a file which is created by the operations schedular and includes data related to job number, process, starting and finishing date as well as main process dates such as frame cut date, infill cut date, lock punch date, lock assembly date, meshing date, assembly date as well as other characteristics such as dimensional and colour of the particular product.

It is possible to move processes to a future date by changing only one of the dates. All the other related dates will then be automatically moved accordingly.

It should be noted that if the dates are moved forward so as the supply date cannot be kept, the system will bring up a warning message. If the process dates end up being after the supply dates then it is necessary to change the supply dates and advise the client.

The operations schedular 71 thus enables manufacturing staff to work out what products need to be made and a schedule is automatically produced of the particular procedures required to produce that product by a set date.

As a corollary to the above it is necessary to monitor the amount of work that is allocated by manufacturing staff. If there are many jobs requiring products to be made by particulars dates then it is necessary to prioritise those jobs.

The operations schedular therefore also provides an operational work sheet file being a report that calculates within a given day all products requiring a given set process.

TABLE 2

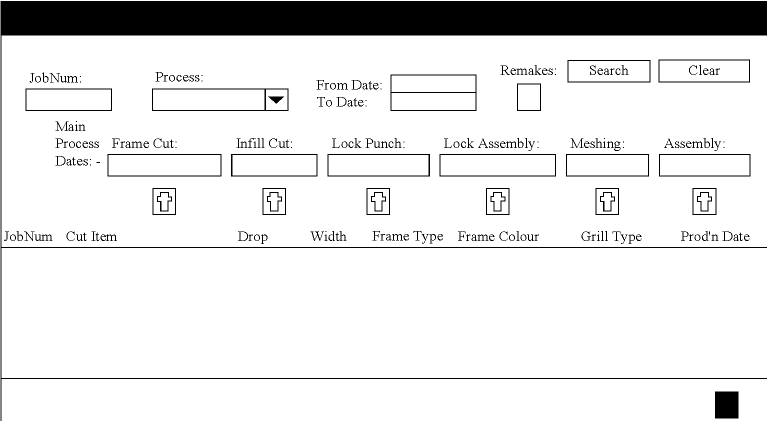

It sorts by product type and allocates the product an ID number that will be identifiable throughout the operational process.

As an example the report will show a particular product, a cut ID, colour frame type, quantity, dimensions, coverings such as a powder coating, and the production date.

The order schedules modules 72 stores files relating to products which need to be outsourced as represented by items 76. Accordingly a listing of outsourced products is provided in an outsourced schedule file. The file lists the dates each product needs to be ready, the date the product was ordered, the date the product is due to arrive and confirmed date of delivery arriving.

The final step in the operations module 13 is controlling product forecasting. Accordingly a forecast reports module 77 has a forecast report sub-program with a file structure which allows a list of products required within a given date range to be retrieved and listing.

The search file also enables a search for jobs that require rework (a list of all products from an order that may be required to be reworked due to the product not being correct), normal jobs only or all jobs.

The forecast reports module 77 also enables data to be retrieved relating to exceeded process dates 78, exceeded supply dates 79 and overdue outsourced products 80.

It is also noted that any job may have an associated priority added to it whereby jobs with a priority can be viewed by using the forecast reports search facility.

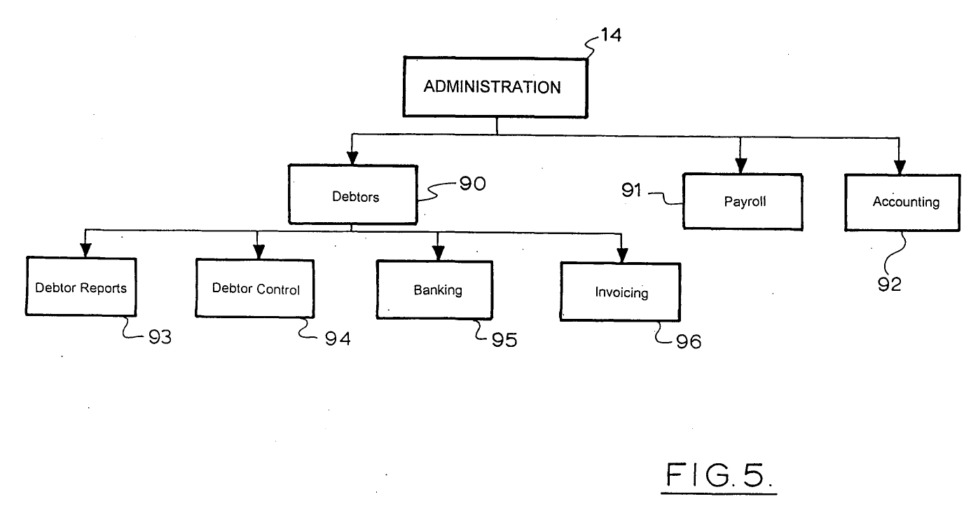

FIG. 5 shows a flow chart of general administration procedures which are controlled by the management software system.

Because the focus of many businesses is in the sales, operations and supply areas, much more time is spent on managing the selling of as much product as possible, rather than the lesser priorities of supplying the product in order to recover any monies owing and to pay creditors by the due date. The administrative duties are often neglected until all other processes are completed.

According to the preferred embodiment an administration module 17 controls key operations associated with debtors, payroll and accounting by way of separate debtors module 90, payroll module 91 and accounting module 92. Preferably the management system of the present invention provides the business with a business administration system that in design reduces structures and controls the workload on the necessary administrative tasks. These tasks however are integrated with the other management tasks which have been previously described.

The debtors module 70 features full debtor control program with automated invoicing backed up by a full reporting structure on our standing accounts.

Separate modules are provided for debtor reports 93, debtor control 94, banking 95 and invoicing 96. Each of the debtor reports 93 are associated with a job/quote and utilise programs which are able to reconcile payments, aged trial balance, debtor summary and debtor ageing. Each of the other administration modules provide typical debtor, payroll and accounting functions which are able to retrieve data from the operations, sales and customer service modules of the management system.

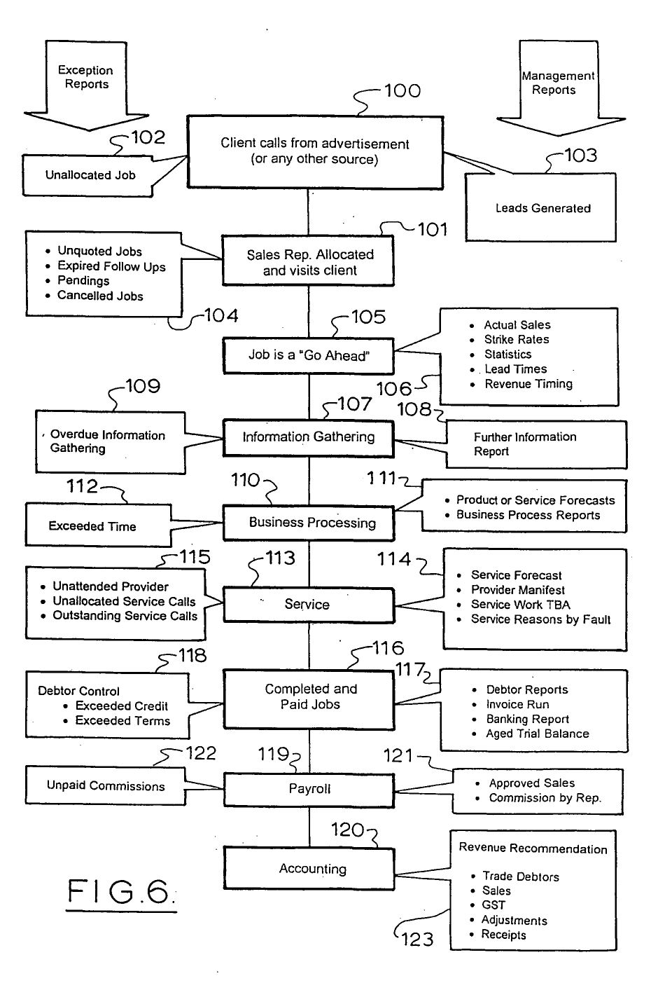

As shown in FIG. 6 an overview is provided of the processes which are monitored and controlled by the management software system of the preferred embodiment of the invention.

The management software system thus accepts data relating to a client and the source of referral which directed the client to the business as referenced by item 100.

The software management program also monitors leads generated 101 from the initial client contact and allocates a sales rep to handle the job of providing a quote for the client, as monitored and controlled by protocols referenced by item 101.

The software management system also monitors any jobs that are not allocated to a sales rep for any particular reason. Thus a module of the software is able to produce an exception report named “Unallocated Job” and referenced by item 102.

The software program ensures that the sales rep allocated with the job visits the client, obtains the necessary data to prepare a quote and then prepares the quote and gives it to the client by a particular date.

As an important part of the software program is to advise management of any procedures that are not completed, module 101 is able to produce exception reports 104 which include details on unquoted jobs, expired follow-ups, pending jobs and cancelled jobs.

If the client approves a quote, then the quote becomes a job which is processed as such by the go-ahead module referenced by item 105. From this module, management reports can be obtained about statistics relating to the quotation process. Reports which are able to be obtained from module 105 are referenced by item 106 and include actual sales, strike rates, statistics, lead times and revenue timing.

Details of a go-ahead job are then processed by an information gathering module of the software program as referenced by item 107. Information necessary in order to start manufacturing of a job is gathered by using management reports 108 which indicate when further information is required and report on what type of information this is.

If information gathering does not take place within stipulated time limits an exceptions report issues as referenced by item 109.

Once all the necessary checks have been made and information is correctly available the business processing part of the software is then operated to ensure that any products and/or services are made available ready for installation. Thus the business processing module 110 covers issues of scheduling, manufacturing and allocation of labour and resources. Management reporting is provided from the business processing module 110 and enables reports 111 on product or service forecasts and business process reports. Any deadlines that are passed in the business processing part of the module are output as exception reports 112.

Once all products and/or service resources are available for installation to occur, service module 113 monitors and controls installation-related activities. It should be noted however that the invention covers not just installation but businesses primarily providing services or businesses providing products alone or a combination of products and services.

Management reports 114 are provided from the service module and these include details on service forecasts, provider manifests, service work to be advised and service reasons by fault.

Problems that may occur within the service routine are provided as exception reports 115 and cover unattended provider, unallocated service calls and outstanding service calls.

When a product has been installed by appropriate installing labour, a completed and paid-jobs module of the software 116 deals with administrative actions associated with the business. Management reports 117 can be obtained from this module and include data on debtor reports, invoice running, bank reports and aged trial balance.

Debtor control is managed using exception reports 118 and include details on exceeded credit and exceeded terms for clients.

Payroll and accounting modules 119 and 120 respectively all form part of a general administration module and are able to process data from other modules as required. The payroll module 119 produces management reports 121 including details on approved sales and commission required by reps. Any unpaid commissions appear as an exceptions report 122.

The accounting module 120 deals with standard revenue reconciliation duties such as trade debtors, sales, gst adjustments and receipts under the management reports 123.

The example given in FIG. 6 gives a brief outline of the overall process involved in managing a business that provides a product such as a security screen to a client in a domestic, commercial or other area of activity. The principals involved however, extend to many types of businesses where a job needs to be quoted and the quote accepted by the client before it becomes a job which is revenue gaining for the business.

It is to be understood that, if any prior art publication is referred to herein, such reference does not constitute an admission that the publication forms a part of the common general knowledge in the art, in Australia or in any other country.

1. A management system for a business, which management system is adapted for implementation by a computer, the management system comprising a job inquiry and quotation means which is adapted to receive data relating to a request from a client to provide a quote for the provision of at least one product and/or service and operate a quote scheduling means to retrieve predetermined quote data whereby a schedule is created for a quote date being a date for providing the quote to the client, a job management means which is adapted to receive data relating to a successful quote approved by a client, including the or each product and or service requested by the client and operate an operations scheduling means to retrieve predetermined operations data to create an operations schedule to schedule resources required for the provision of the or each product and/or service for the successful quote and store a provision deadline being the date by which the product and/or service of the successful quote should be provided to the client who approved the successful quote.

2. The management system as claimed in claim 1 wherein the operations scheduling means is adapted to schedule labour and goods required for the provision of the or each product and/or service for each successful quote.

3. The management system as claimed in claim 2 wherein the resources include labour and goods.

4. The management system as claimed in claim 2 or 3 wherein the operations scheduling means is adapted to schedule procedures involving the resources, which procedures enable the provision of the or each product and/or service for each successful quote.

5. The management system as claimed in claim 4 including an administration means which is adapted to record data relating to input and output costs of the business being managed by the management system.

6. The management system as claimed in claim 4 or 5 wherein the job enquiry and quotation means is adapted to create a job enquiry labour database for storing names of persons able to act on the enquiry and provide the quote.

7. The management system as claimed in claim 6 wherein the job enquiry and quotation means is adapted to create a database of products and/or services available for the quote.

8. The management system as claimed in claim 7 wherein the operations scheduling means includes quote allocation means which is adapted to allocate a quote person from the job enquiry labour database to provide the quote.

9. The management system as claimed in claim 8 wherein the job enquiry and quotation means is adapted to create a pending quotes request database including data relating to the client requesting quote and the or each product and/or service for which a quote is requested.

10. The management system as claimed in claim 9 wherein the quote data includes the quote person, the client, the product and/or service, the date for visiting the client and the due date for supplying the quote to the client.

11. The management system as claimed in claim 10 wherein the job enquiry and quotation means includes quote monitoring means for monitoring when each quote request is answered by the quote person.

12. The management system as claimed in claim 11 wherein the job enquiry and quotation means is adapted to create a source of enquiry database which includes a list of sources of enquiries.

13. The management system as claimed in claim 12 including a setting means which is adapted to receive reference data relating to each product and/or service available to the business.

14. The management system as claimed in claim 13 wherein the job enquiry and quotation means includes a data entry means which is adapted to receive data relating to the request from a client, being a new job and create a file for each new job.

15. The management system as claimed in claim 14 wherein each job file includes data relating to the client and the product and/or service requested by the client.

16. The management system as claimed in claim 15 wherein the quote allocation means is adapted to retrieve quote persons names from the job enquiry labour database whereby one or more quote persons names may be added to the new job file to thereby provide the quote requested by the client.

17. The management system as claimed in claim 16 wherein the quote allocation means is adapted to automatically search databases and allocate a quote person to a new job based on predetermined criteria relating to jobs already allocated to the quote person.

18. The management system as claimed in claim 17 wherein the quote monitoring means includes an overdue indicator which is adapted to provide an overdue output indication if a quote request is not answered by the due date by the quote person.

19. The management system as claimed in claim 18 wherein the job enquiry and quotation means is adapted to record unsuccessful quotes and data related thereto.

20. The management system as claimed in claim 19 wherein the job enquiry and quotation means includes a job enquiry manifest means for creating a job manifest for each quote request using data from any one or more of the databases.

21. The management system as claimed in claim 20 wherein the job enquiry manifest means is adapted to create a job manifest for each quote person.

22. The management system as claimed in claim 21 wherein the job manifest includes data relating to each quote request including client details, product and/or service details and due date details.

23. The management system as claimed in claim 1 or claim 22 wherein the job management means is adapted to create a resourcing database including data relating to each product and/or service available to be provided by the business, raw materials available to make the or each type of product and/or service and resource labour available to provide each type of product and/or service.

24. The management system as claimed in claim 23 wherein the job management means includes a manufacturing operation means which includes procedures required to manufacture at least one type of product.

25. The management system as claimed in claim 24 wherein the manufacturing operation means includes timing data for setting times for commencing and finishing procedures required for manufacture of one or more products.

26. The management system as claimed in claim 25 wherein the operation scheduling means includes resource allocation means which is adapted to retrieve data from the resourcing database and allocate resource labour to produce at least one product and/or service required for one or more clients.

27. The management system as claimed in claim 26 wherein the operations scheduling means is adapted to create a file having data relating to a job/quote, being a successful quote, the products and/or services associated with the job/quote and the manufacturing operation means.

28. The management system as claimed in claim 27 wherein the manufacturing operation means includes a plurality of manufacturing operations options, each manufacturing operation option being adapted to store data relating to procedures required to complete at least one manufacturing process for a product.

29. The management system as claimed in claim 28 wherein the manufacturing operation means includes a process scheduler which is adapted to store timing data for at least one of the manufacturing operations for a particular job/quote and calculate and produce timing data associated with other manufacturing operations for the job/quote.

30. The management system as claimed in claim 29 wherein the resource allocation means is adapted to retrieve procedures from the manufacturing operation means, which procedures are required to produce the/each product and/or service whereby a resourcing manifest is able to be created including data relating to the requested product and/or service of the successful quote, the job/quote, the allocated product resource labour and completion date for providing the/each product and/or service whereby it is available for the client of the successful quote.

31. The management system as claimed in claim 1 or 30 including provision control means which is adapted to record each provision date, being the date for providing the or each product and/or service of a successful quote to the associated client.

32. The management system as claimed in claim 31 wherein the provision control means is adapted to create a provision database including data on each provision person available to provide the or each service to an associated client.

33. The management system as claimed in claim 32 wherein the provision control means is adapted to create a provision manifest including the name of each provision person to provide the or each product and/or service, the job/quote, provision procedures including procedures to provide the or each product and/or service to an associated client and a provision deadline being a deadline for providing the or each product and/or service to the associated client.

34. A computer program for controlling a business, the computer program comprising a job inquiry and quotation means which is adapted to control a data processor to receive and store data relating to a request from a client to provide a quote for the provision of at least one product and/or service and operate a quote scheduling means to schedule a quote data being a date for providing the quote to the client, and a job management means which is adapted to control a data processor to receive data relating to each successful quote approved by each client including the or each product and/or service requested by each client, control an operations scheduling means which is adapted to schedule labour and goods required for the provision of the or each product and/or service for each successful quote and store a provision deadline for each successful quote, the provision deadline being the date by which the product and/or service of the successful quote should be provided to the client who approved the successful quote.

35. A computer program as claimed in claim 34 wherein the quote scheduling means is adapted to schedule quote labour to provide the quote, a quote deadline for the quote labour to provide the quote, a visit deadline being a date for the quote labour to visit the client and obtain data relating to preparing the quote and control the data processor to set up a quote labour manifest including data relating to selected successful quotes allocated to the quote labour.
